(19) United States
(12) Patent Application Publication
(10) Pub. No.: US 2023/0134481 A1
(43) Pub. Date: May 4, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Mie (JP)

(72) Inventors: Shinji TANAKA, Mie (JP); Shinji NOZAKI, Mie (JP)

(21) Appl. No.: 17/911,532

(22) PCT Filed: Feb. 26, 2021
(86) PCT No.: PCT/JP2021/007251

§ 371 Date: Sep. 14, 2022

(30) Foreign Application Priority Data
Mar. 19, 2020 (JP) 2020-048624

(51) Int. Cl. H01R 13/631; H01R 13/64; H01R 13/516; H01R 13/629; H01R 13/623

(52) U.S. Cl. CPC H01R 13/631; H01R 13/64; H01R 13/516; H01R 13/623; H01R 13/62905

(57) ABSTRACT

A connector is provided with a first housing (10), a second housing (20) connectable to the first housing (10), a guide functional unit (45) for enabling the first and second housings (10, 20) to approach/separate from each other in a relatively unrotatable state, a rotary member (30) for surrounding the first and second housings (10, 20), the rotary member being rotatable about an axis parallel to a connecting direction of the first and second housings (10, 20), and a cam functional unit (46) for causing the first and second housings (10, 20) to approach each other as the rotary member (30) is relatively rotated with respect to the first and second housings (10, 20).

### TECHNICAL FIELD

The present disclosure relates to a connector.

### BACKGROUND

Patent Document 1 discloses a connector requiring a reduced operation force at the time of connection. This connector is configured by rotatably mounting a lever on a housing. In connecting the connector to a mating connector, a rotational force is given to an operating portion of the lever with a cam groove of the lever and a cam follower of the mating connector engaged. Then, an operation force to be given to the lever is reduced by a boosting action by the principle of leverage.

### Prior Art Document

### Patent Document

Patent Document 1: JP 2019-129079 A

### SUMMARY OF THE INVENTION

### Problems to Be Solved

Since the lever rotates about an axis orthogonal to a connecting direction of the connector and the mating connector, an arcuate space for allowing the rotation of the operating portion of the lever is necessary around the connector. Since the arcuate space has to be secured to bulge toward an outer peripheral side of the connector, it is difficult to perform a connecting operation in a narrow space.

A connector of the present disclosure was completed on the basis of the above situation and aims to realize space saving.

### Means to Solve the Problem

The present disclosure is directed to a connector with a first housing, a second housing connectable to the first housing, a guide functional unit for enabling the first and second housings to approach/separate from each other in a relatively unrotatable state, a rotary member for surrounding the first and second housings, the rotary member being rotatable about an axis parallel to a connecting direction of the first and second housings, and a cam functional unit for causing the first and second housings to approach each other as the rotary member is relatively rotated with respect to the first and second housings.

### Effect of the Invention

According to the present disclosure, space saving can be realized.

### BRIEF DESCRIPTION OF THE DRAWINGS

FIG. 1 is a section showing a state where the connection of a first housing and a second housing is started in a connector of one embodiment.

FIG. 2 is a section showing a state while the first and second housings are being connected.

FIG. 3 is a section showing a state where the connection of the first and second housings is completed.

FIG. 4 is a perspective view of the first housing viewed obliquely from behind.

FIG. 5 is a section of the first housing.

FIG. 6 is a perspective view of the second housing viewed obliquely from front.

FIG. 7 is a perspective view of a rotary member viewed obliquely from front.

FIG. 8 is a section of the rotary member.

FIG. 9 is a perspective view of an operating member viewed obliquely from front.

### DETAILED DESCRIPTION TO EXECUTE THE INVENTION

### Description of Embodiments of Present Disclosure

First, embodiments of the present disclosure are listed and described.

The connector of the present disclosure is provided with a first housing, a second housing connectable to the first housing, a guide functional unit for enabling the first and second housings to approach/separate from each other in a relatively unrotatable state, a rotary member for surrounding the first and second housings, the rotary member being rotatable about an axis parallel to a connecting direction of the first and second housings, and a cam functional unit for causing the first and second housings to approach each other as the rotary member is relatively rotated with respect to the first and second housings. According to the configuration of the present disclosure, if the rotary member is rotated, the first and second housings are brought closer and connected to each other by the cam functional unit. Since the rotary member rotates about the axis parallel to the connecting direction of the first and second housings, an arcuately bulging operation space needs not be secured on outer peripheral sides of the both housings. Therefore, the connector of the present disclosure can realize space saving.

(2) Preferably, the guide functional unit is configured by fitting a first guide portion formed in the first housing and a second guide portion formed in the second housing. According to this configuration, the number of components can be reduced as compared to the case where the guide functional unit is a component separate from the first and second housings.

(3) Preferably, in (2), one of the first and second guide portions is a projection-like guide portion, the housing not formed with the projection-like guide portion, out of the first and second housings, is formed with a spiral guiding portion, and the first and second guide portions relatively rotate to be positioned to fit each other by sliding the projection-like guide portion in contact with the guiding portion. According to this configuration, even if the first and second guide portions are deviated in position in a circumferential direction in the process of bringing the first and second housings closer to each other, the first and second guide portions can be fit by the spiral guiding portion.

(4) Preferably, in (1) to (3), the cam functional unit includes a spiral cam groove formed in one peripheral surface, out of an inner peripheral surface of the rotary member and an outer peripheral surface of the first housing, and a cam follower formed on the other peripheral surface, out of the inner peripheral surface of the rotary member and the outer peripheral surface of the first housing, the cam follower sliding along the cam groove. According to this configuration, since the cam functional unit is formed in the rotary member and the first housing, the number of components can be reduced as compared to the case where the cam functional unit is a component separate from the rotary member and the first housing.

(5) Preferably, in (4), the rotary member and the second housing are formed with a holding portion for holding the second housing in such a state that the second housing is not relatively displaced in a direction away from the first housing with respect to the rotary member. According to this configuration, if the rotary member is relatively displaced in the axial direction while being relatively rotated with respect to the first housing, the second housing is displaced in the axial direction integrally with the rotary member. In this way, the second housing is connected to the first housing.

(6) Preferably, in (1) to (5), the rotary member is formed with an opening penetrating from an outer peripheral surface to an inner peripheral surface of the rotary member. According to this configuration, a connected state of the first and second housings can be visually confirmed from the outside of the rotary member.

(7) Preferably, in (1) to (6), a tubular operating member is provided which is disabled to relatively rotate with respect to the first and second housings and is formed with a spiral drive groove in an inner peripheral surface, and a driven projection configured to slide in the drive groove is formed on an outer peripheral surface of the rotary member. According to this configuration, if the operating member is relatively displaced in the axial direction with respect to the rotary member, the rotary member is rotationally driven and the first and second housings are connected or separated. Since a moving direction of the operating member is the axial direction, a space for operating the operating member is unnecessary on the outer peripheral sides of the first and second housings.

### Details of Embodiment of Present Disclosure

### Embodiment

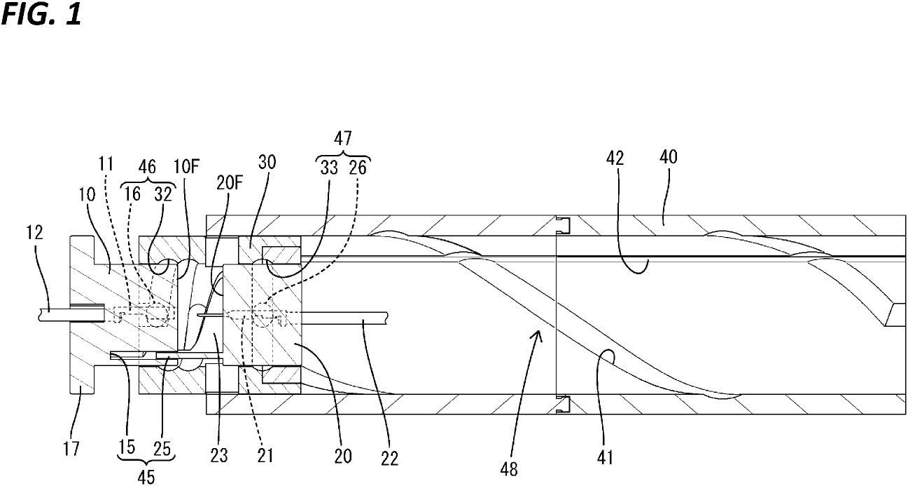

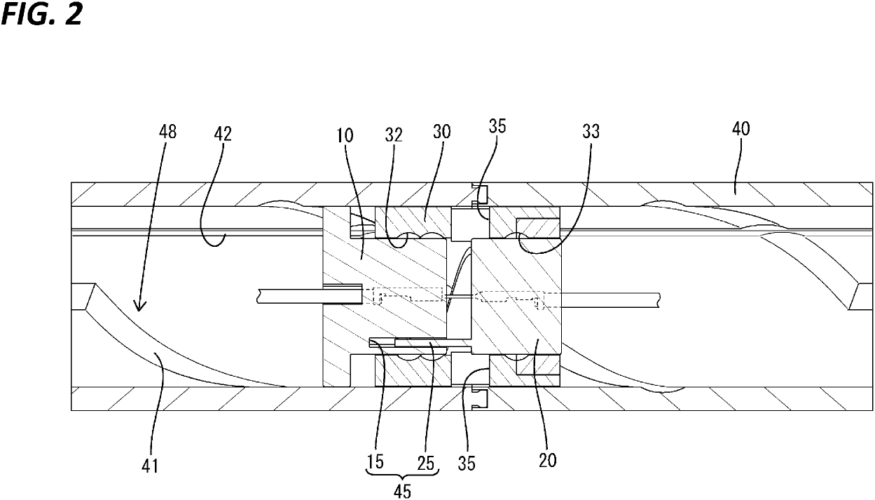

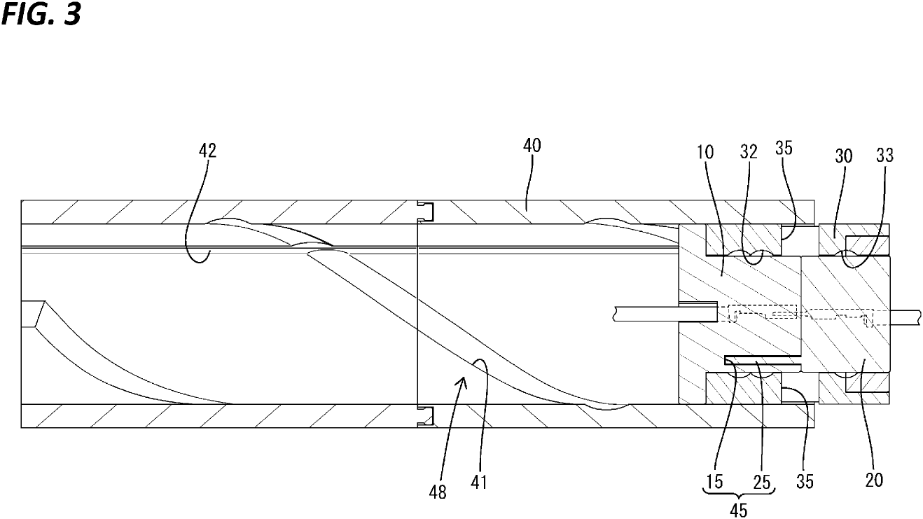

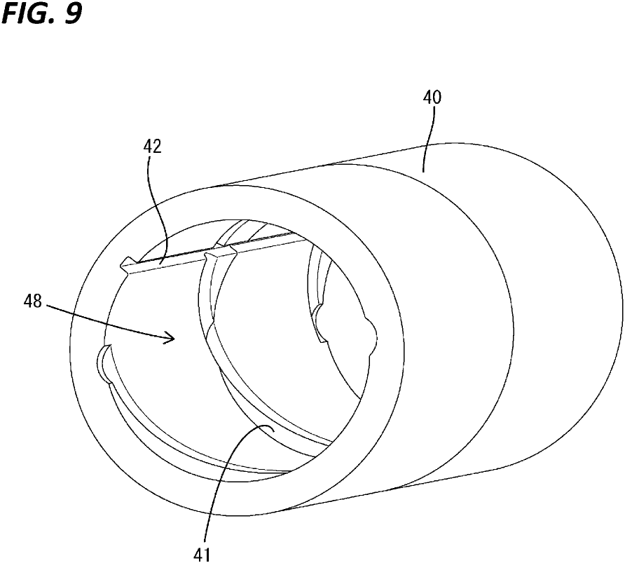

A specific embodiment of a connector of the present disclosure is described below with reference to FIGS. 1 to 9. Note that the present invention is not limited to these illustrations and is intended to be represented by claims and include all changes in the scope of claims and in the meaning and scope of equivalents. In this embodiment, a left side of FIGS. 1 to 3, 5, 6, 8 and 9 is defined as a front side concerning a front-rear direction.

As shown in FIGS. 1 to 3, a connector of this embodiment includes a first housing 10, a second housing 20, a rotary member 30 and an operating member 40. The first and second housings 10, 20 are connected by being brought closer in an axial direction with a first connection surface 10F of the first housing 10 and a second connection surface 20F of the second housing 20 facing each other. A “connecting direction” of the first and second housings 10, 20 and the “axial direction” of the first housing 10, the second housing 20, the rotary member 30 and the operating member 40 are used as synonyms.

The first housing 10 is made of synthetic resin and has a cylindrical shape having an axis oriented in the front-rear direction as a whole. Female first terminal fittings 11 connected to first wires 12 are accommodated inside the first housing 10. The first wires 12 are drawn out to the outside of the first housing 10 from the front end surface of the first housing 10. The rear end surface of the first housing 10 serves as the first connection surface 10F facing the second housing 20.

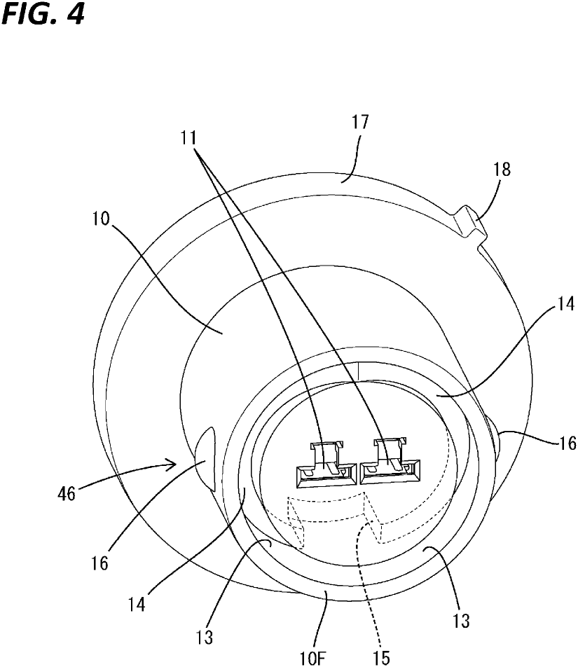

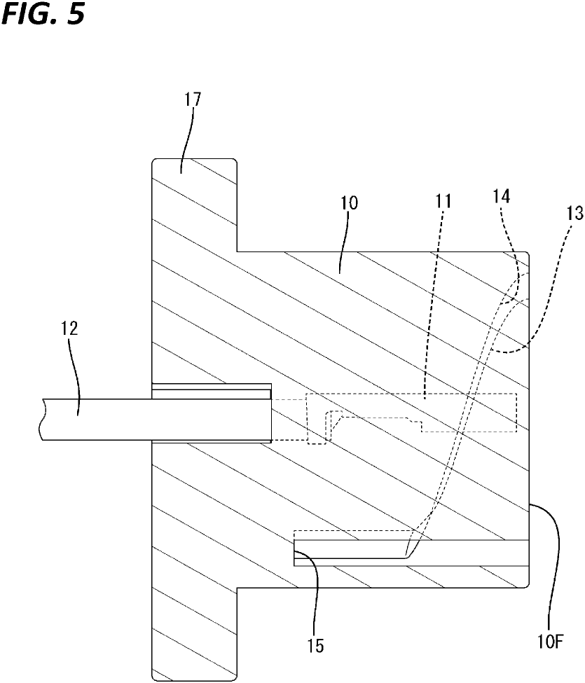

As shown in FIGS. 4 and 5, the first housing 10 is integrally formed with a pair of guiding portions 13 and one first guide portion 15. The pair of guiding portions 13 have a line-symmetrical shape in a back view from behind the first housing 10. Each guiding portion 13 is formed by recessing a region more on an outer peripheral side than the first terminal fittings 11 into a semicircular groove concentric with the first housing 10. The back surfaces of the pair of guiding portions 13 function as spiral guiding surfaces 14 inclined with respect to the axis of the first housing 10. Spiral directions of the pair of guiding surfaces 14 are opposite to each other.

The first guide portion 15 is recessed backward (forward) in parallel to the axis from backmost end parts of the pair of guiding surfaces 14. The first guide portion 15 constitutes a guide functional unit 45 in cooperation with a second guide portion 25 of the second housing 20 to be described later.

As shown in FIG. 4, a pair of projection-like cam followers 16 separated by an interval of 180° in a circumferential direction are formed on the outer peripheral surface of the first housing 10. The cam followers 16 constitute a cam functional unit 46 in cooperation of cam grooves 32 of the rotary member 30 to be described later. A flange portion 17 having a circular shape concentric with the first housing 10 and expanded in diameter is formed on the outer periphery of a front end part of the first housing 10. A detent projection 18 is formed on the outer periphery of the flange portion 17.

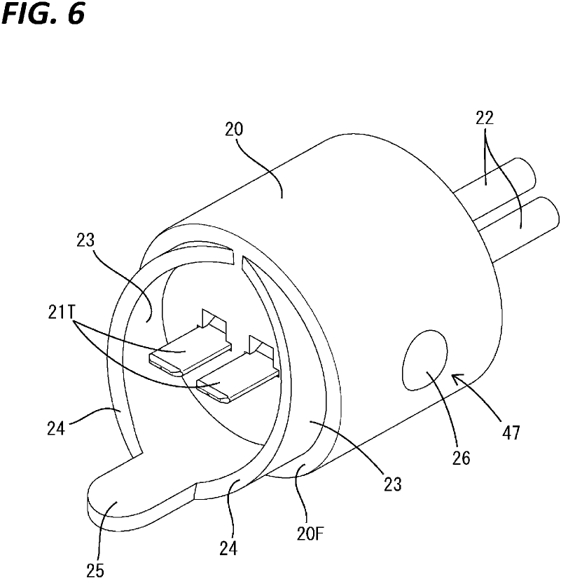

The second housing 20 is made of synthetic resin and has a cylindrical shape having an axis oriented in the front-rear direction as a whole. As shown in FIG. 1, male second terminal fittings 21 connected to second wires 22 are accommodated inside the second housing 20. As shown in FIG. 6, tabs 21T on the front ends of the second wires 22 project forward from the front end surface of the second housing 20. The second wires 22 are drawn out to the outside of the second housing 20 from the rear end surface of the second housing 20. The front end surface of the second housing 20 serves as the second connection surface 20F facing the first housing 10.

The second housing 20 is integrally formed with a pair of projecting wall portions 23 and one second guide portion 25. The pair of projecting wall portions 23 have a line-symmetrical shape in a front view from front of the second housing 20. Each projecting wall portion 23 is formed by causing a region more on an outer peripheral side than the second terminal fittings 21 to project into a semicircular shape concentric with the second housing 20. Projecting end surfaces 24 of the pair of projecting wall portions 23 are spirally inclined with respect to the axis of the second housing 20. Spiral directions of the pair of projecting end surfaces 24 are opposite to each other. A spiral pitch of the pair of projecting end surfaces 24 is equal to that of the pair of guiding surfaces 14.

The second guide portion 25 projects forward in parallel to the axis from foremost end parts of the pair of projecting end surfaces 24. The second guide portion 25 is a projection-like guide portion. A pair of holding projections 26 separated by an interval of 180° in the circumferential direction are formed on the outer peripheral surface of the second housing 20. The holding projections 26 constitute a holding portion 47 in cooperation with a holding groove 33 of the rotary member 30 to be described later.

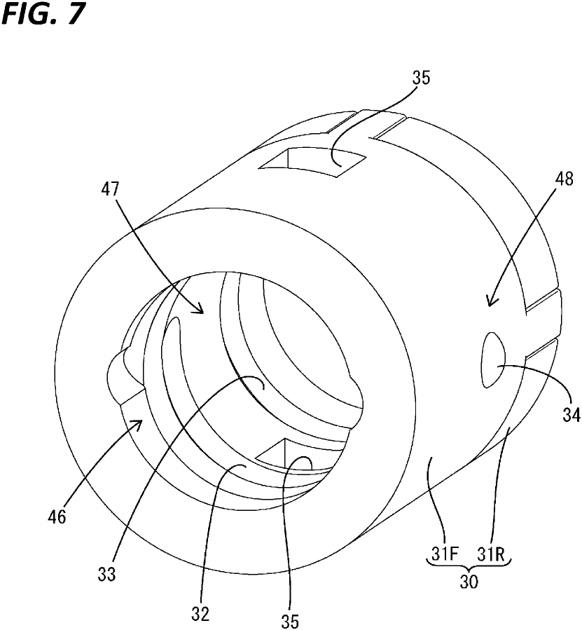

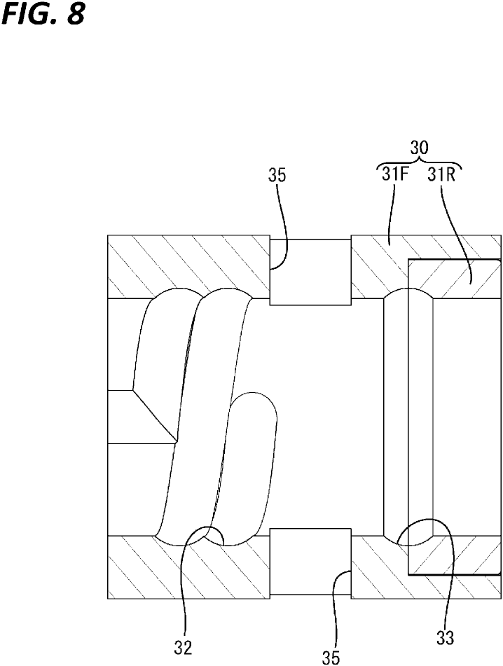

The rotary member 30 is made of synthetic resin and has a cylindrical shape having an axis oriented in the front-rear direction as a whole. As shown in FIGS. 7 and 8, the rotary member 30 is configured by coaxially uniting a hollow cylindrical front component 31F and a hollow cylindrical rear component 31R in the front-rear direction. The spiral cam grooves 32 are formed in the inner peripheral surface of the front component 31F. A formation range of the cam grooves 32 in the axial direction is a region from the front end of the rotary member 30 (front component 31F) to a position forward of the rear end of the rotary member (front component 31F). The front ends of the cam grooves 32 are open as entrances for allowing the cam followers 16 of the first housing 10 to enter the cam grooves 32. A spiral pitch of the cam grooves 32 is set smaller than that of drive grooves 41 of the operating member 40 to be described later. As show in FIG. 1, the cam grooves 32 constitute the cam functional unit 46 in cooperation with the cam followers 16 of the first housing 10 to be described later.

The holding groove 33 is formed in a region behind the cam groove 32, out of the inner peripheral surface of the rotary member 30. The holding groove 33 is not spiral, but has a true circular shape on a virtual plane orthogonal to the axis. The holding groove 33 is constituted by a cut portion formed in the inner periphery of a rear end part of the front component 31F and having a quarter circular cross-section and a cut portion formed in the inner periphery of a front end part of the rear component 31R and having a quarter circular cross-section. The holding groove 33 constitutes the holding portion 47 in cooperation of the aforementioned holding projections 26 of the second housing 20.

A pair of driven projections 34 separated by an interval of 180° in the circumferential direction are formed on the outer peripheral surface of the rotary member 30. The driven projections 34 constitute a rotational force transmitter 48 in cooperation with the drive grooves 41 of the operating member 40 to be described later. The rotary member 30 is formed with a pair of openings 35. The openings 35 penetrate from the outer peripheral surface to the inner peripheral surface of the rotary member 30. In the axial direction, the openings 35 are disposed between the cam grooves 32 and the holding groove 33. The first connection surface 10F of the first housing 10 and the second connection surface 20F of the second housing 20 butt against each other between the cam grooves 32 and the holding groove 33.

The operating member 40 has a cylindrical shape having an axis oriented in the front-rear direction as a whole. The spiral drive grooves 41 are formed in the inner peripheral surface of the operating member 40. The spiral pitch of the drive grooves 41 is set larger than that of the cam grooves 32 of the rotary member 30. The front ends of the drive grooves 41 are open in the front end surface of the operating member 40. One detent groove 42 is formed in the inner peripheral surface of the operating member 40. The front end of the detent groove 42 is open in the front end surface of the operating member 40. The detent groove 42 linearly extends in parallel to the axis.

Next, an operation procedure of connecting the first and second housings 10, 20 in the connector of this embodiment is described. First, the second housing 20 and the rotary member 30 are assembled. In assembling, the front and rear components 31F, 31R are separated, the front component 31F is externally fit to the outer periphery of the first housing 10 from front, and the rear component 31R is externally fit to the outer periphery of the first housing 10 from behind. If the front and rear components 31F, 31R are united, the holding projections 26 are fit into the holding groove 33 at the same time as the holding groove 33 is configured. In the above way, the assembling of the rotary member 30 and the second housing 20 is completed.

With the rotary member 30 and the second housing 20 assembled, the holding projections 26 are caught in the holding groove 33, thereby making relative displacements of the second housing 20 and the rotary member 30 in the axial direction (both forward and rearward directions) impossible. The holding projections 26 and the holding groove 33 slide in contact with each other, whereby the second housing 20 and the rotary member 30 are relatively rotatable.

Subsequently, the first housing 10 and the rotary member 30 are assembled. In assembling, a rear end part of the first housing 10 is inserted into the rotary member 30 from front of the rotary member 30. At this time, the cam followers 16 of the second housing 20 are inserted into front end parts of the cam grooves 32. At this point of time, the first and second housings 10, 20 are not connected yet, and the first and second guide portions 15, 25 are also not fit yet. In the above way, the first housing 10, the second housing 20 and the rotary member 30 are assembled.

After the first housing 10, the second housing 20 and the rotary member 30 are assembled, a front end part of the operating member 40 is externally fit to a rear end part of the rotary member 30 and the driven projections 34 are inserted into the drive grooves 41. Subsequently, the detent projection 18 of the first housing 10 is fit into a front end part of the detent groove 42. In this state, the first and second housings 10, 20 are disabled to relatively rotate with respect to the operating member 40, but the operating member 40 can be relatively displaced forward in the axial direction with respect to the first and second housings 10, 20.

Thereafter, the first housing 10 and the operating member 40 are brought closer to each other in the axial direction without being relatively rotated. Then, the drive grooves 41 of the operating member 40 and the driven projections 34 of the rotary member 30 slide each other, wherefore the rotary member 30 is relatively rotationally driven with respect to the first and second housings 10, 20 by the inclination of the drive grooves 41. At this time, friction resistance caused by the sliding of the cam grooves 32 and the cam followers 16 is generated, but the rotary member 30 can be reliably rotated even if an operation force in the axial direction applied to the operating member 40 is small since the spiral pitch of the drive grooves 41 is larger than that of the cam grooves 32.

If the rotary member 30 is relatively rotated, the cam grooves 32 and the cam followers 16 slide each other, and the rotary member 30 and the first housing 10 are relatively displaced in the axial direction by the inclination of the cam grooves 32. At this time, a relative displacement direction of the rotary member 30 with respect to the first housing 10 is a forward direction. The rotary member 30 and the second housing 20 integrally move due to the fitting of the holding groove 33 and the holding projections 26. Therefore, if the operating member 40 and the first housing 10 are brought closer, the first and second housings 10, 20 are brought closer and connected.

The connector of this embodiment is provided with the first housing 10, the second housing 20 connectable to the first housing 10, the guide functional unit 45, the rotary member 30 and the cam functional unit 46. The guide functional unit 45 is a functional part for enabling the first and second housings 10, 20 to approach/separate from each other in a relatively unrotatable state. The rotary member 30 surrounds the first and second housings 10, 20. The rotary member 30 is rotatable about the axis parallel to the connecting direction of the first and second housings 10, 20. In short, the rotary member 30 is rotatable about the axis. The cam functional unit 46 causes the first and second housings 10, 20 to approach each other as the rotary member 30 is relatively rotated with respect to the first and second housings 10, 20.

According to this configuration, if the rotary member 30 is rotated, the first and second housings 10, 20 are brought closer and connected by the cam functional unit 46. Since the rotary member 30 is rotated about the axis parallel to the connecting direction of the first and second housings 10, 20, it is not necessary to secure an arcuately bulging operation space on the outer peripheral sides of the both housings. Therefore, the connector of the present disclosure can realize space saving.

The guide functional unit 45 is configured by fitting the first guide portion 15 formed in the first housing 10 and the second guide portion 25 formed in the second housing 20. The first guide portion 15 constituting the guide functional unit 45 is integrally formed to the first housing 10, and the second guide portion 25 constituting the guide functional unit 45 is integrally formed to the second housing 20. Therefore, the connector of the present disclosure can reduce the number of components as compared to the case where the guide functional unit 45 is a component separate from the first and second housings 10, 20.

Out of the first and second guide portions 15, 25, the second guide portion 25 is a projection-like guide portion. Out of the first and second housings 10, 20, the second housing 20 not formed with the projection-like guide portion (second guide portion 25) is formed with the spiral guiding portions 13. The first and second guide portions 15, 25 relatively rotate to be positioned to fit each other by sliding the projection-like guide portion (second guide portion 25) in contact with the guiding portion 13.

According to this configuration, even if the first and second guide portions 15, 25 are deviated in position in the circumferential direction in the process of bringing the first and second housings 10, 20 closer, the front end part of the second guide portion 25 slides in contact with the spiral guiding portion 13. By this sliding contact, the second guide portion 25 is guided to approach the first guide portion 15, wherefore the first and second guide portions 15, 25 can be reliably fit.

The cam functional unit 46 includes the spiral cam grooves 32 formed in the inner peripheral surface of the rotary member 30 and the cam followers 16 formed on the outer peripheral surface of the first housing 10. The cam followers 16 slide along the cam grooves 32 as the rotary member 30 and the first housing 10 are relatively rotated. The cam grooves 32 constituting the cam functional unit 46 are integrally formed in the rotary member 30, and the cam followers 16 constituting the cam functional unit 46 are integrally formed in the first housing 10. Therefore, the connector of this embodiment can reduce the number of components as compared to the case where the cam functional unit 46 is a component separate from the rotary member 30 and the first housing 10.

The rotary member 30 is integrally formed with the holding groove 33 constituting the holding portion 47. The second housing 20 is integrally formed with the holding projections 26 constituting the holding portion 47. The holding groove 33 and the holding projections 26 hold the second housing 20 in such a state that the second housing 20 is not relatively displaced in a direction away from the first housing 10 with respect to the rotary member 30. According to this configuration, if the rotary member 30 is relatively displaced forward in the axial direction while being relatively rotated with respect to the first housing 10, the second housing 20 is displaced forward in the axial direction integrally with the rotary member 30. In this way, the second housing 20 is connected to the first housing 10.

The rotary member 30 is formed with the openings 35 penetrating from the outer peripheral surface to the inner peripheral surface of the rotary member 30. According to this configuration, the connected state of the first and second housings 10, 20 can be visually confirmed from the outside of the rotary member 30.

The connector of this embodiment includes the tubular operating member 40 disabled to relatively rotate with respect to the first and second housings 10, 20 and formed with the spiral drive grooves 41 in the inner peripheral surface. The driven projections 34 configured to slide in the drive grooves 41 are formed on the outer peripheral surface of the rotary member 30. According to this configuration, if the operating member 40 is relatively displaced in the axial direction with respect to the rotary member 30, the rotary member 30 is rotationally driven and the first and second housings 10, 20 are connected or separated. Since a moving direction of the operating member 40 is the axial direction, a space for operating the operating member 40 is unnecessary on the outer peripheral sides of the first and second housings 10, 20.

### Other Embodiments

The present invention is not limited to the above described and illustrated embodiment and is represented by claims. The present invention is intended to include all changes in the scope of claims and in the meaning and scope of equivalents and also include the following embodiments.

Although the first guide portion has a recessed shape and the second guide portion has a projecting shape in the above embodiment, the first guide portion may have a projecting shape and the second guide portion may have a recessed shape.

Although the guide functional unit is formed in the first and second housings in the above embodiment, the guide functional unit may be a component separate from the first and second housings.

Although the first and second housings are formed with the spiral guiding portions in the above embodiment, the spiral guiding portions may not be provided.

Although the cam functional unit is formed in the rotary member and the first housing in the above embodiment, the cam functional unit may be a component separate from the rotary member and the first housing.

Although the cam grooves are formed in the inner peripheral surface of the rotary member and the cam followers are formed on the outer peripheral surface of the first housing in the above embodiment, the cam grooves may be formed in the outer peripheral surface of the first housing and the cam followers may be formed on the inner peripheral surface of the rotary member.

Although the holding portion is composed of the holding groove formed in the inner peripheral surface of the rotary member and the holding projections formed on the outer peripheral surface of the second housing in the above embodiment, a holding portion may be composed of a holding groove formed in the outer peripheral surface of the second housing and holding projections formed on the inner peripheral surface of the rotary member.

Although the rotary member is formed with the openings in the above embodiment, the rotary member may include no opening.

Although the rotary member is rotated using the operating member in the above embodiment, the rotary member may be directly rotated without using the operating member.

Although the operating member and the first housing are connected to disable the operating member to relatively rotate with respect to the first and second housings in the above embodiment, the operating member and the second housing may be connected.

Although the first housing includes the female terminal fittings and the second housing includes the male terminal fittings in the above embodiment, the first housing may include male terminal fittings and the second housing may include female terminal fittings.

### List of Reference Numerals

10 ... first housing
10F ... first connection surface
11 ... first terminal fitting
12 ... first wire
13 ... guiding portion
14 ... guiding surface
15 ... first guide portion
16 ... cam follower
17 ... flange portion
18 ... detent projection
20 ... second housing
20F ... second connection surface
21 ... second terminal fitting
21T ... tab
22 ... second wire
23 ... projecting wall portion
24 ... projecting end surface
25 ... second guide portion
26 ... holding projection
30 ... rotary member
31F ... front component
31R ... rear component
32 ... cam groove
33 ... holding groove
34 ... driven projection
35 ... opening
40 ... operating member
41 ... drive groove
42 ... detect groove
45 ... guide functional unit
46 ... cam functional unit
47 ... holding portion
48 ... rotational force transmitter

1. A connector, comprising:
a first housing;
a second housing connectable to the first housing;
a guide functional unit for enabling the first and second housings to approach/separate from each other in a relatively unrotatable state;
a rotary member for surrounding the first and second housings, the rotary member being rotatable about an axis parallel to a connecting direction of the first and second housings; and
a cam functional unit for causing the first and second housings to approach each other as the rotary member is relatively rotated with respect to the first and second housings.

2. The connector of claim 1, wherein the guide functional unit is configured by fitting a first guide portion formed in the first housing and a second guide portion formed in the second housing.

3. The connector of claim 2, wherein:
one of the first and second guide portions is a projection-like guide portion,
the housing not formed with the projection-like guide portion, out of the first and second housings, is formed with a spiral guiding portion, and
the first and second guide portions relatively rotate to be positioned to fit each other by sliding the projection-like guide portion in contact with the guiding portion.

4. The connector of claim 1 , wherein the cam functional unit includes:
a spiral cam groove formed in one peripheral surface, out of an inner peripheral surface of the rotary member and an outer peripheral surface of the first housing; and
a cam follower formed on the other peripheral surface, out of the inner peripheral surface of the rotary member and the outer peripheral surface of the first housing, the cam follower sliding along the cam groove.

5. The connector of claim 4, wherein:
the rotary member and the second housing are formed with a holding portion for holding the second housing in such a state that the second housing is not relatively displaced in a direction away from the first housing with respect to the rotary member, and
the second housing and the rotary member are made integrally movable in the connecting direction with respect to the first housing by the holding portion.

6. The connector of claim 1 , wherein the rotary member is formed with an opening penetrating from an outer peripheral surface to an inner peripheral surface of the rotary member.

7. The connector of claim 1 , comprising a tubular operating member disabled to relatively rotate with respect to the first and second housings, the operating member being formed with a spiral drive groove in an inner peripheral surface, wherein:
a driven projection configured to slide in the drive groove is formed on an outer peripheral surface of the rotary member.
